(19) United States
(12) Patent Application Publication
(10) Pub. No.: US 2016/0085332 A1
(43) Pub. Date: Mar. 24, 2016

(54) TOUCH SENSITIVE HOLOGRAPHIC DISPLAY SYSTEM AND METHOD OF USING THE DISPLAY SYSTEM

(71) Applicant: CONTINENTAL AUTOMOTIVE SYSTEMS INC., AUBURN HILLS, MI (US)

(72) Inventors: OSCAR HERRERA-MORALES, TIAQUEPAQUE (MX); LUIS GUTIERREZ-VALDEZ, TIAQUEPAQUE (MX); HIRAM ABURTO-CRESPO, TIAQUEPAQUE (MX)

(21) Appl. No.: 14/493,392

(22) Filed: Sep. 23, 2014

(51) Int. Cl. G06F 3/042; G03H 1/00

(52) U.S. Cl. CPC G06F 3/042; G03H 1/0005; G06F 2203/04804; G03H 2001/0061

(57) ABSTRACT

A touch sensitive holographic display system includes a transparent screen having a rear side and a front side. A projector is configured for creating a holographic image at the front of the screen by projecting an image towards the rear side of the screen. The projector is located at the rear side of the screen. A touch sensor is configured for sensing a touching of the holographic image at the front side of the screen. An electronic controller is connected to the projector for controlling the projector and is connected to the touch sensor for receiving an indication that the holographic image has been touched. By touching the image, which can be an icon, a user can control or access a function of an automobile.

### BACKGROUND OF THE INVENTION

1. Field of the Invention

The invention generally relates to a communication interface that allows a user to communicate with a device that is electronically connected to the interface. More particularly, the invention relates to a touch sensitive holographic display system that allows a user to interactively communicate with a device that is electronically connected to the touch sensitive holographic display system.

2. Description of the Related Art

Touch sensitive holographic display systems are known that project holographic images on flat screens. An example is disclosed in Issued U.S. Pat. No. 8,515,194 to Lawrence et al., the disclosure of which is entirely incorporated by reference.

### BRIEF SUMMARY OF THE INVENTION

It is an object of the invention to provide a touch sensitive holographic display system capable of forming holographic images on a screen of any desired three-dimensional geometric shape.

It is an additional object of the invention to incorporate the touch sensitive holographic display system into an automotive control system so that the user can access information from the control system and/or access functions of auxiliary devices in the automobile as a result of the user interacting with the touch sensitive holographic display system.

It is another object of the invention to make it easier for a user to communicate with the touch sensitive holographic display system by displaying the holographic images in the form of icons such that each icon has a visual appearance which intuitively conveys the information or function that will be accessed in response to a user touching the icon.

With the foregoing and other objects in view there is provided, in accordance with the invention, a touch sensitive holographic display system, including: a transparent screen having a rear side and a front side, and a projector configured for creating a holographic image at the front of the screen by projecting a projected image towards the rear side of the screen. The projector is located at the rear side of the screen. The touch sensitive holographic display system also includes: a touch sensor configured for sensing a touching of the holographic image at the front side of the screen; and an electronic controller connected to the projector for controlling the projector and connected to the touch sensor for receiving an indication that the holographic image has been touched.

In accordance with an added feature of the invention, the holographic image is an icon having an appearance that intuitively conveys information or a function that will be accessed in response to a sensed touching of the icon.

In accordance with an additional feature of the invention, the screen has a three-dimensional shape.

In accordance with another feature of the invention, the screen has a spherical shape.

In accordance with a further feature of the invention, the screen is integrated into an interior portion of an automobile.

In accordance with a further added feature of the invention, the screen is disposed in a dashboard of an automobile.

In accordance with a further additional feature of the invention, the touch sensor includes a touch screen film disposed on the screen.

In accordance with yet another feature of the invention, the projector is configured for projecting the projected image in a form that is reversed compared to an appearance of the holographic image at the front of the screen.

With the foregoing and other objects in view there is provided, in accordance with the invention, a method of using a touch sensitive holographic display system. The method includes the following steps: obtaining the touch sensitive holographic display system described herein; projecting the projected image from the projector to the rear side of the screen; sensing, with the touch sensor, whether the holographic image has been touched at the front side of the screen; and accessing information or accessing a function of a component electrically connected to the touch sensitive holographic display system in response to the touch sensor sensing that the holographic image has been touched.

In accordance with an added feature of the invention, the holographic image is an icon having an appearance that intuitively conveys the information or the function that will be accessed in response to a sensed touching of the icon.

In accordance with an additional feature of the invention, the screen is integrated into an interior portion of an automobile.

In accordance with a further feature of the invention, the screen is disposed in or on a dashboard of an automobile.

In accordance with a further added feature of the invention, the component that is accessed is mobile telephone, a computer, an automobile stereo, or a control system of an automobile.

Other features which are considered as characteristic for the invention are set forth in the appended claims.

Although the invention is illustrated and described herein as embodied in a touch sensitive holographic display system and a method of using the touch sensitive holographic display system, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a schematic view of an exemplary embodiment of a touch sensitive holographic display system;

FIG. 2 is a diagrammatic view of an example of the touch sensitive holographic display system showing the screen formed with a spherical shape;

FIG. 3 is a schematic view of an exemplary embodiment of a touch sensitive holographic display system; and

FIG. 4 is a block diagram showing steps of a method of using the touch sensitive holographic display system.

### DESCRIPTION OF THE PREFERRED EMBODIMENTS OF THE INVENTION

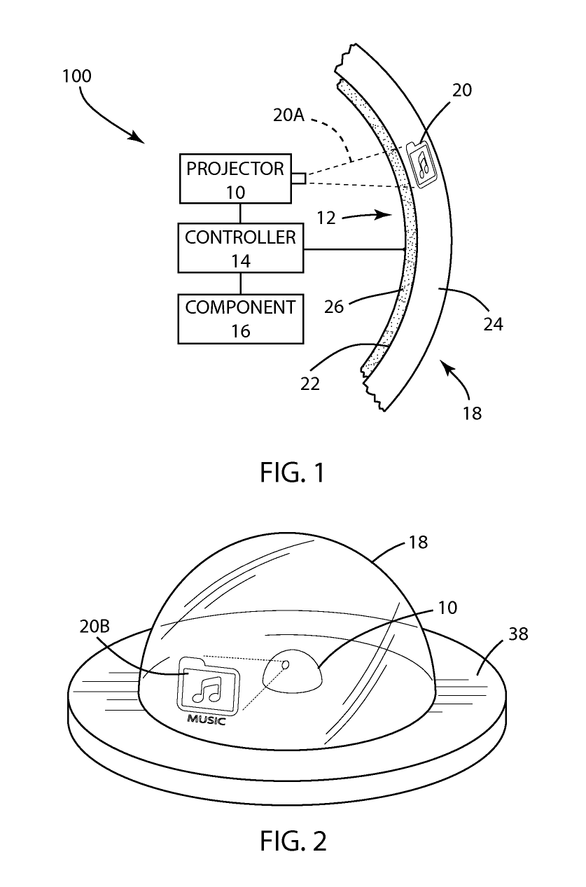

Referring now to the figures of the drawing in detail and first, particularly to FIG. 1 thereof, there is shown a diagrammatic view of an exemplary embodiment of a touch sensitive holographic display system 100. The display system 100 includes a transparent screen 18 in which the screen 18 and particularly the surface of the screen 18 can have any desired three-dimensional geometrical shape. The screen 18 has a rear side 22 and a front side 24. The display system 100 includes a projector 10 configured for creating a holographic image 20 at the front 24 of the screen 18 by projecting a projected image 20A towards the rear side 22 of the screen 18. The projector 10 is located at the rear side 22 of the screen 18. The projector 10 is configured for projecting the projected image 20A in a form that is reversed compared to an appearance of the holographic image 20 at the front 24 of the screen 18. The display system 100 includes a touch sensor 12 configured for sensing a touching of the holographic image 20 at the front side 24 of the screen 18. The display system 100 also includes an electronic controller 14 connected to the projector 10 for controlling the projector 10 and connected to the touch sensor 12 for receiving an indication that the holographic image 20 has been touched. The electronic controller 14 can include a microprocessor along with the memory typically required for operating the microprocessor, for example. By touching the image 20, a user can control or access a function of an automobile or of an auxiliary device in an automobile. This user can be the driver or a passenger in the automobile. The touch sensor 12 preferably includes a touch screen film 26 disposed on the rear side 22 of the screen 18. However, the touch sensor 12 may alternatively be constructed by using an infrared sensor system or a proximity sensor system.

FIG. 2 shows an example of the touch sensitive holographic display system 100 in which the screen 18 is formed with a spherical shape. In this case, the screen 18 has the shape of one half of a sphere. The projector 10 is shown displaying a holographic image 20 in the form of an icon 20B. This exemplary icon 20B and all of the other icons described herein have an appearance that intuitively conveys information or a function that will be accessed in response to a sensed touching of the icon 20B. The exemplary icon 20B that is shown is a musical note. Such a musical note is intuitively associated with music and the likelihood that a user will associate such a note with a stereo should be clearly evident. This icon 20B in the form of a musical note could be displayed in a case where one or more functions of the automobile stereo will be accessed by toughing the icon.

Examples of icons that can be intuitively associated with particular functions could be displayed are numerous. Even if the user must be shown the association at first, the association will be quickly remembered by user at subsequent times. For example, an icon of a telephone could be displayed so that the user can touch the icon to access a telephone. As another example, an icon with the symbol associated with a particular internet browser, such as, Internet Explorer™ published by Microsoft™ or Chrome™ published by Google™ could be displayed so that the user can touch the icon to access the Internet using the particular browser. An icon typically associated with a map could be displayed so that the user can touch the icon to access an electronic map, perhaps with GPS. An icon typically associated with an envelope icon could be displayed so that the user can touch the icon to access the user's email. An icon typically associated with a social network, such as, Facebook™ could be displayed so that the user can touch the icon to access a social network. An icon typically associated with a calendar could be displayed so that the user can touch the icon to access the user's electronic calendar. Certainly with the benefit of the disclosure herein, the person of ordinary skill in the art can identify many other functions that could be assessed by displaying a particular icon that is relevant to that function and that would intuitively inform the user of the available function upon display of the particular icon.

Icons could also be used to enable the user to access information relating to a particular state of an automobile system, for example, the brake fluid level, transmission fluid level, power steering fluid level, coolant fluid level, and/or the fuel level. These icons could have a visual appearance of, for example, a brake, a transmission, a steering wheel, the level of a fluid, or perhaps a gas pump handle.

One or more icons could also be used to enable the user to access information relating to an alarm state of an automobile system, for example, low tire pressure, low engine oil level, and/or high engine temperature. One or more icons could also be used to enable the user to access information relating to a detected malfunction in an automobile system, such as the transmission and/or engine. One or more icons could be used to enable a user to access information related to require automobile maintenance, such as a needed oil change or timing belt replacement.

The electronic controller 14 can cause the projector 10 to sequentially display each one of a plurality of different icons. During the sequential display, each one of the different icons will be shown as a floating holographic image for a predetermined time period and then that icon will cease to be shown and the next icon in the sequence will be shown as a floating holographic image for a predetermined time period. The sequential display will continue until either the user touches one of the icons during the time it is displayed or the sequential display has been shown for a period of time exceeding a limit value. In this way, the user can simply wait until the icon, which is intuitively associated with the function or information the user desires to access, is displayed and the user can touch the icon to access that function or information.

In the Example shown in FIG. 2, the screen 18 is formed with a spherical shape. However, the screen could be shaped as a cylinder, a cube, a rectangle, a triangle, a pyramid, or as a three dimensional portion of any of those objects. It should be understood that the screen 18 can be formed in any desired shape. Unlike the known screens, the screen 18 is not limited to a flat screen, but rather can be formed in any desired non-flat shape. The screen 18 can be integrated into any desired interior portion of an automobile. Such interior portions can be, for example, the ceiling of the automobile, a center console, or a dashboard.

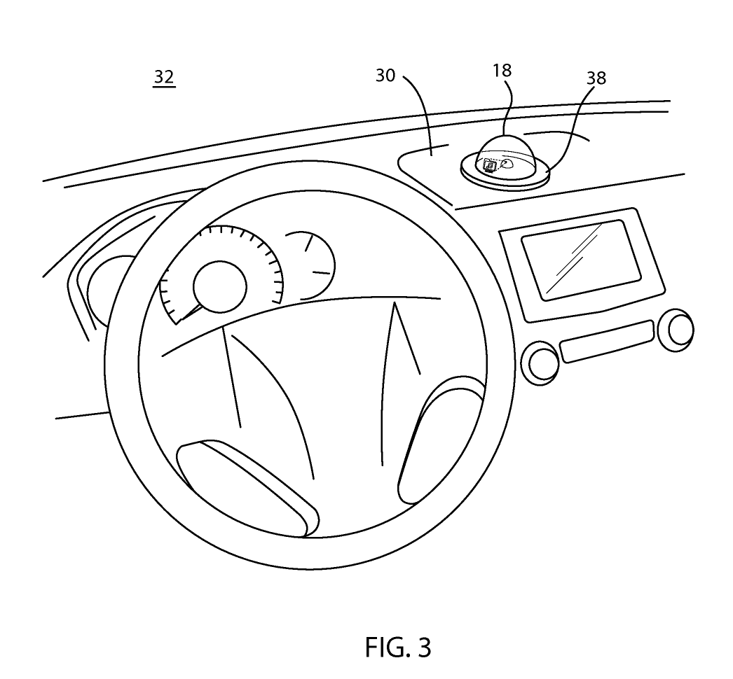

FIG. 3 shows an example in which the screen 18 is integrated on disposed on the dashboard 30 of an automobile 32. The touch sensitive holographic display system 100 may include a base 38 with the projector 10 mounted thereon. The screen 18 is also mounted on the base 38. Any necessary electronics, such as the electronic controller 14 can be mounted inside the base 38.

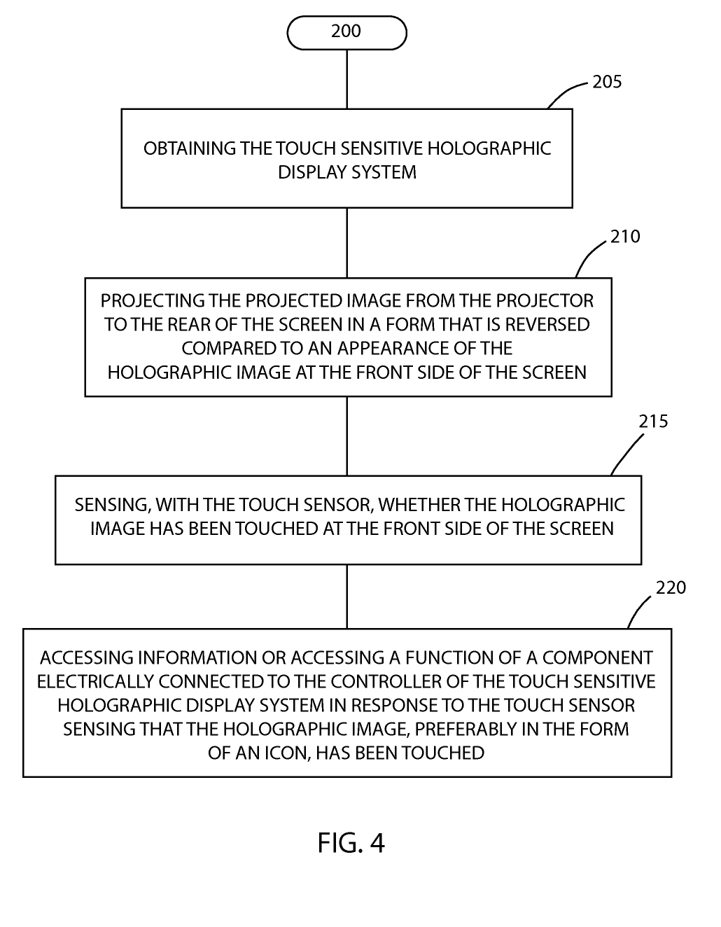

FIG. 4 shows a block diagram illustrating the steps of a method 200 of using the touch sensitive holographic display system 100. The method includes a step 205 of obtaining the touch sensitive holographic display system 100. The method includes a step 210 of projecting the projected image from the projector 10 to the rear side of the screen 18 in a form that is reversed compared to an appearance of the holographic image at the front side of the screen 18. The method includes a step 215 of sensing, with the touch sensor 12, whether the holographic image has been touched at the front side of the screen 18. The method includes a step 220 of accessing information or accessing a function of a component 16 electrically connected to the controller 14 of the touch sensitive holographic display system 100 in response to the touch sensor 12 sensing that the holographic image 20, preferably in the form of an icon 20B, has been touched. The component 16 can be, for example, a mobile telephone, a computer, an automobile stereo, or a control system of an automobile.

Now that the important features of the invention have been explained, it should be apparent to the person of ordinary skill in the art that numerous variants are possible. Thus, it should be understood that the invention is not limited to the specific examples discussed herein.

We claim:

1. A touch sensitive holographic display system, comprising:
a transparent screen having a rear side and a front side;
a projector configured for creating a holographic image at said front of said screen by projecting a projected image towards said rear side of said screen, said projector located at said rear side of said screen;
a touch sensor configured for sensing a touching of the holographic image at said front side of said screen; and
an electronic controller connected to said projector for controlling said projector and connected to said touch sensor for receiving an indication that the holographic image has been touched.

2. The touch sensitive holographic display system according to claim 1, wherein:
said holographic image is an icon having an appearance that intuitively conveys information or a function that will be accessed in response to a sensed touching of said icon.

3. The touch sensitive holographic display system according to claim 1, wherein:
said screen has a three-dimensional shape.

4. The touch sensitive holographic display system according to claim 1, wherein:
said screen has a spherical shape.

5. The touch sensitive holographic display system according to claim 1, wherein:
said screen is integrated into an interior portion of an automobile.

6. The touch sensitive holographic display system according to claim 1, wherein:
said screen is disposed on a dashboard of an automobile.

7. The touch sensitive holographic display system according to claim 1, wherein:
said touch sensor includes a touch screen film disposed on said screen.

8. The touch sensitive holographic display system according to claim 1, wherein:
said projector is configured for projecting the projected image in a form that is reversed compared to an appearance of the holographic image at said front of said screen.

9. A method of using a touch sensitive holographic display system, which comprises:
obtaining a touch sensitive holographic display system including: a transparent screen having a rear side and a front side, a projector configured for creating a holographic image at the front of the screen by projecting a projected image towards the rear side of the screen, the projector located at the rear side of the screen, a touch sensor configured for sensing a touching of the holographic image at the front side of the screen, and an electronic controller connected to the projector for controlling the projector and connected to the touch sensor for receiving an indication that the holographic image has been touched;
projecting the projected image from the projector to the rear side of the screen;
sensing, with the touch sensor, whether the holographic image has been touched at the front side of the screen; and
accessing information or accessing a function of a component electrically connected to the touch sensitive holographic display system in response to the touch sensor sensing that the holographic image has been touched.

10. The method according to claim 9, which comprises: wherein: the holographic image is an icon having an appearance that intuitively conveys the information or the function that will be accessed in response to a sensed touching of the icon.

11. The method according to claim 9, wherein: the screen has a three-dimensional shape.

12. The method according to claim 9, wherein: the screen has a spherical shape.

13. The method according to claim 9, which comprises: integrating the screen into an interior portion of an automobile.

14. The method according to claim 9, which comprises: disposing the screen on a dashboard of an automobile.

15. The method according to claim 9, wherein: the touch sensor includes a touch screen film disposed on the screen.

16. The method according to claim 9, wherein: the projector is configured for projecting the projected image in a form that is reversed compared to an appearance of the holographic image at the front side of the screen.

17. The method according to claim 9, wherein the component that is accessed is selected from the group consisting of a mobile telephone, a computer, an automobile stereo, and a control system of an automobile.
